(19) United States
(12) Patent Application Publication
(10) Pub. No.: US 2006/0234627 A1
(43) Pub. Date: Oct. 19, 2006

(54) Mobile radio combiner and multi-coupler unit

(75) Inventors: Andrew J. Cartin, Plano, TX (US); Charles A. York, Lewisville, TX (US)

Correspondence Address: John E. Vandigriff;Hammerle Finley Law Firm, Suite 300, 1660 S. Stemmons Frwy., Lewisville, TX, 75067, US

(73) Assignee: dbSpectra, Inc.

(21) Appl. No.: 11/108,134

(22) Filed: Apr. 18, 2005

(51) Int. Cl. H04B 7/14

(52) U.S. Cl. 455/24

(57) ABSTRACT

A broadband RF Spectrum Transmitter combiner is duplexed with a Receiver splitter/multicoupler through a unique circulator/isolator configuration to provide a bi-directional radio input, unidirectional input at the receiver multicoupler to the radio and a unidirectional output from the radio to the transmitter combiner output. The circulator/isolator duplexer circuitry may be configured for any RF frequency band and in conjunction with the use of a same frequency band transmit combiner and receiver multicoupler provide the cohabitiation of mobile radios with isolation is excess of 60 dB. The multiple ports may be connected to multiple radio units, each with a different frequency, and combined and connected to a transmit antenna and a receive antenna. The duplexer-combiner configuration is used then to combine the bi-directional antenna port on the radios into a pair of antennas spaced apart from one another as to not degrade the isolation provided by the duplexer-combiner configuration.

### FIELD OF THE INVENTION

The invention relates to an RF (Radio frequency) transmitter and receiver combiner, and more particularly to a radio backup combiner which connects a plurality of mobile radio antenna port connections with one receive and one transmit antenna connection utilized over a band of frequencies.

### BACKGROUND OF THE INVENTION

Combiner and coupler devices have been used to combine RF transmitters and receivers. These devices are used in RF transmit and receive systems in the provision of dividable signal paths whether multiple paths being combined into one or alternatively one path being divided into multiple paths. Prior art examples are as follows:

U.S. Pat. No. 5,563,558 defining an asymmetric network with n signal paths, k input terminals and m output terminals. U.S. Pat. No. 6,781,749 defining an ILC device (interleaving combiner) that uses bidirectional hybrid amplification in an interleaved wavelength-division multiplexing (WDM) system.

U.S. Pat. No. 6,600,776 defining a technology for combining multi-elements in an adaptive antenna array.

The example patents above focus on devices that provide for each application of dividing or combining with some inference to combinational application to combining transmitters and receivers. These examples exemplify background and set the stage for the invention.

### SUMMARY OF THE INVENTION

The RF combiner systems uses a series of stripline ferrite circulator-isolators as a combiner providing a symmetrical-bidirectional network with n inputs and m outputs. m is always less than 4 and n is 2 or more. The inputs, n, are bidirectional with outputs m being unidirectional with a minimum of one port with a direction into the device, and a minimum of one port with a direction out of the device. The invention is unique in the use of a circulator as a transmit and receiver combiner with the addition of two single junction ioslators in the network providing port to port isolation of 50 db or more.

The n input ports may connect single port transmitter/receiver portable or mobile radio over the frequency spectrum of 150 MHz to 20 GHz. The outputs m are connected to filters or antennas; one transmit and one receive minimum. The application intent of the invention is to reduce the number of required antennas to be less than the number of required radios.

The technical advance represented by the invention as well as the unique use of the circulator, isolator combination previously discussed as well as other objects thereof will become apparent from the following description of a preferred embodiment of the invention when considered in conjunction with the accompanying drawings, and the novel features set forth in the appended claims.

### BRIEF DESCRIPTION OF THE DRAWINGS

FIG. 1. shows the combiner and milticoupler system of the present invention; and

FIG. 2 shows a single unit showing signal flow paths of the unique isolator, circulator configuration.

### DESCRIPTION OF A PREFERRED EMBODIMENT

Definitions

An Isolator is defined as a circulator with a grounded resistor at one of its ports.

A Circulator is defined as an asymmetrical one way device providing low loss in one direction of signal travel and high attenuation in the opposite direction from one port to another.

Description

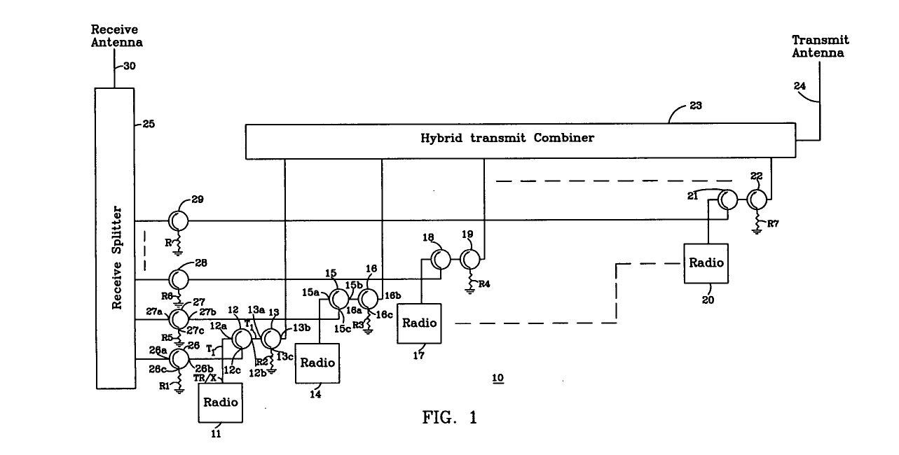

FIG. 1 shows a multi-channel radio combiner system 10 that includes a receive antenna 30 and a transmit antenna 24 that are used in combination with a plurality of radio systems, for example radios 11, 14, 17, and 20.

Radio 11 is connected at 12a to circulator 12 which is connected at 13a to isolator 13, and a third isolator 26 at 26a. Radio 11 may transmit through circulator 12 and isolator 13. Isolator 13 is connected to hybrid transmit combiner 23, which is connected to transmit antenna 24. Signals generated by other radios entering into hybrid transmit combiner 23 are blocked from radio 11 transmitter by isolator 13 and circulator 12. Any signal from another radio connected to the hybrid transmit combiner 23 will be isolated from Radio 11 by the sum of the isolation provided by the circulator 12 and isolator 13.

Radio 11 is connected to receive splitter 25 through circulator 12 and isolator 26. A received signal from received antenna 30 and received splitter 25 is passed through isolator 26 terminals 26a and 26b) and through circulator 12 (terminals 12a and 12c) to radio 11. When radio 11 is transmitting, the transmitted signal will be reduced by isolator 26 and circulator 12 since terminal 26c is grounded through resistor R1 and terminal 13c is grounded through a resistor R2. This prevents a transmitted signal from going to receive splitter 25 and to other radios and the received antenna 30.

Radio 14 is connected at 15a to circulator 15 which is connected to terminal 16a of isolator 16 and a second isolator 27 at 27b. Radio 14 may transmit through circulator 15 and isolator 16. Isolator 16 is connected to hybrid transmit combiner 23, which is connected to transmit antenna 24. Signals generated by other radios and transmitted to hybrid transmit combiner 23 are reduced from radio 14 by isolator 16 and circulator 15. Any signal from another radio connected to hybrid transmit combiner 23 will be reduced in isolator 16, and further reduced in circulator 15 with maximum attenuation of unwanted signals in radio 14 transmitter.

Radio 14 is connected to receive splitter 30 through isolator 27 at (through 27a and 27b) and circulator 15 (through 15a and 15c). A received signal from receive antenna 30 and receive splitter 25 is passed through isolator 27 and circulator 15 to radio 14 receiver. When radio 14 is transmitting, the transmitted signal will be reduced through circulator 15 and isolator 27 since terminal 27c is grounded through resistor R. This reduces a transmitted signal from going to the receive splitter and to other radios and the received antenna.

Radio 17, and circulator 18, isolator 19, and isolator 28 function together the same as the circulators and isolators attached to radios 11 and 14. Other radios may be attached as the illustrated ones as long as the hybrid transmit combiner and receiver splitter are attached to the additional radios utilizing the preferred circulator and isolator configuration. Radio 20 is to the hybrid transmitter combiner 23 through circulator 21 and isolator 22. Resistor R7 provides attenuation to signals in the transmit combiner 23 as demonstrated in the other circuit topologies.

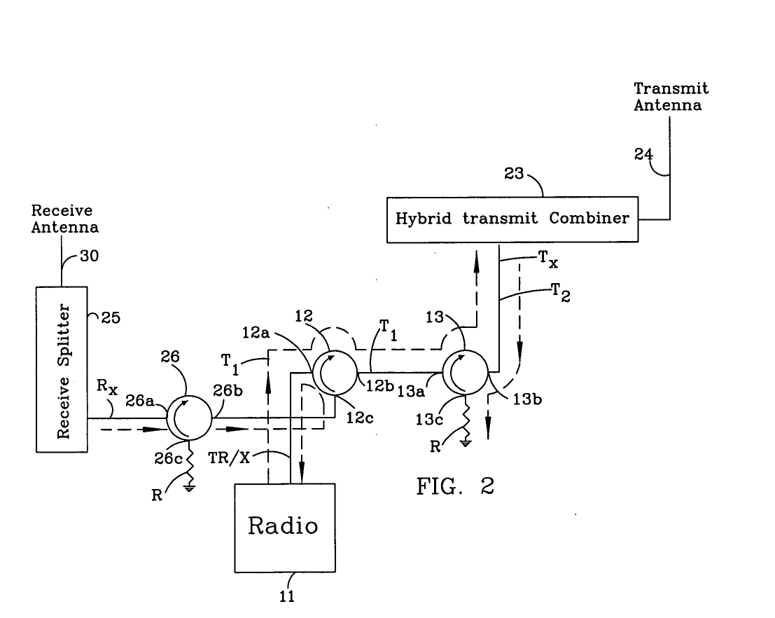

FIG. 2 illustrates a single radio 11 attachment to circulators 12 and isolators 13 and 26 and hybrid transmit combiner 23 and received splitter 25. The signal flow for received/transmit functions are as follows: When radio 11 is to transmit a signal, the transmitted signal, from terminal Tr/x is on line T1, enters circulator 12 at 12a, the signal is directed through circulator 12 and out terminal 12b. The signal then enters isolator 13 at 13a, and exits at 13b, and then is directed through hybrid transmit combiner 23 to antenna 24. Transmit signal out of terminal 12c (circulator 12) is attenuated before it reaches receiver splitter 25 since the signal entering isolator 26 at 26b and is attenuated by virtue of the ground that is applied at terminal 26c and resistor R.

Any signal T2 out of hybrid transmit combiner at terminal 13b is attenuated back to circulator 13 since the signal entering 13b is attenuated at terminal 13c through resistor R2, and is further attenuated through circulator 12 back to radio 11.

When radio 11 receives a signal, the signal is received on receive antenna 30, is direct through received splitter 25 and signal Rx is received through circulator-isolator 26 and at circulator 12 terminal 12c and is output at terminal 12a to radio 11, terminal TR/X.

What is claimed:

1. A multi-channel bi-directional radio combiner system that includes a receive antenna port and a transmit antenna port used in combination with a plurality of radio systems, comprising:
transmit and receive antennas that are isolated from one another;
a plurality of common port transmit/receive radios connected to a hybrid transmit combiner;
a circulator/isolator duplexer consisting of a bi-directional circuit consisting of a circulator for combining the input of the transmitter hybrid combiner and the output of the receiver splitter; and
an additional pair of isolators to enhance the port to port isolation/attenuation provided by the circulator duplexer.

2. The multi-channel radio combiner system according to claim 1, wherein the combination of two isolators and a circulator provides increased isolation between a Transmitter combiner of any type and a Receiver mulicoupler of any type and thereby enhance system performance which otherwise would not be possible.

3. The multi-channel radio combiner system according to claim 1, wherein each signal, transmit and receive, passes through a circulator duplexer and an additional circulator/isolator in each path to the hybrid transmit combiner and receiver splitter.

4. The multi-channel radio combiner system according to claim 1, wherein each hybrid transmit combiner has multiple input terminals and a transmit antenna terminal, and any stray signal from an input terminal of the hybrid transmit combiner from another radio is suppressed by an isolator.

5. The multichannel radio combiner system according to claim 4, wherein the non symmetrical response of an isolator and circulator are made functional and enhanced by the shared use of a common load resistor.

6. The multi-channel radio combiner system according to claim 1, wherein there is one circulator and two isolators associated with each radio.

7. The multi-channel radio combiner system according to claim 6, wherein the two isolators, each with resistor load, share said load with the circulator/duplexer.

8. A multi-channel by directional radio combiner system that includes a receive antenna port and a transmit antenna port used in combination with a plurality of radio systems, comprising:
a hybrid transmitter combiner connected to a plurality of radios, each radio connected to the hybrid transmit combiner through a circulator acting as a duplexer and through an isolator and a common load resistor on the isolator; and
a receive splitter connected to a plurality of radios, each radio connected to the receiver splitter through the same circulator/duplexer and through a second isolator with a common load resistor on the isolator.

9. The multichannel radio combiner system according to claim 8, wherein first and second isolators have a terminal terminated through a resistor load.

10. The multi-channel radio combiner system according to claim 8, wherein each signal, transmit and receive, passes through a circulator/duplexer and then through an isolator with a common resistor load before being input to the hybrid transmit combiner and received from the receive splitter through a second isolator with a common load resistor and through the same circulator/duplexer to the radio.

11. The multi-channel radio combiner system according to claim 10, wherein a suppressed signal is terminated to ground through a common load resistor.
